(19) United States
(12) Patent Application Publication
(10) Pub. No.: US 2002/0080034 A1
(43) Pub. Date: Jun. 27, 2002

(54) Medication reminder device and systems and methods utilizing same

(76) Inventor: Eli Yahalom, Carmei Yosef (IL)

Correspondence Address: G. E. EHRLICH LTD., ANTHONY CASTORINA, SUITE 207, 2001 JEFFERSON DAVIS HIGHWAY, ARLINGTON, VA, 22202, US

(21) Appl. No.: 09/748,781

(22) Filed: Dec. 27, 2000

(51) Int. Cl. G08B 23/00

(52) U.S. Cl. 340/573.1; 340/539; 340/286.01

(57) ABSTRACT

A portable medication reminder device is provided. The portable medication reminder device includes: (a) processing unit being for generating a medication regimen and an interactive game; and (b) at least one output device for conveying said medication regimen and interactive game to a user, said interactive game being designed and configured for motivating a user to interact therewith and thus to develop an avidity for said portable medication reminder device, thereby ensuring that said medication regimen is communicated to said user.

### FIELD AND BACKGROUND OF THE INVENTION

The present invention relates to a medical reminder device and to a system and method of utilizing same. More particularly, the present invention relates to a device which motivates a user to comply with a medication regimens thereof.

Drug related illnesses comprise a significant portion of the medical care needs of Americans today. It is estimated that 17% of all emergency room visits are the direct result of noncompliance with prescription drugs. Adverse drug reactions are responsible for 30,000 deaths per year and 1.5 million hospital admissions per year. Estimates of cost to the United States economy from drug related illnesses range from $50 to $100 billion per year.

Noncompliance with prescription medication is particularly prevalent among the elderly. 80% of the 36.3 million people over the age of 65 are on an active medication regime, many taking multiple medications daily. It is estimated that approximately 50 percent do not comply correctly with their medication regimen. Population experts say that by the year 2003, 83 million Americans will be over the age of 50, and by the year 2010, that figure will be over 100 million. Failure to comply with a prescribed medication regimen is recognized as one of the major health-care issues today.

Substantial efforts are being made to address this problem, many through technological means. Prior art reflects a number of devices that alert patients to the need to take their medicine. There exists a number of in-home pill or medication dispensers, such as that described by U.S. Pat. No. 5,405,011 to Haber, U.S. Pat. No. 5,575,392 to Cutler, and U.S. Pat. No. 5,641,091 to Danes/Havar which automatically dispense the correct medications.

U.S. Pat. No. 6,018,289 issued to Sekura, et al, discloses an electronic device clipped on to a pill dispenser which alerts patients when they have failed to take their medications. In addition, reminder devices have been incorporated into cable set top boxes and into wrist watches, see for example U.S. Pat. No. 5,157,640 issued to Backner and U.S. Pat. No. 6,075,755 to Zarchan.

Technology, including electronic identification means such as a bar codes and RFID tags, timers mechanical and electronic, and all manner of hard wired and wireless communications systems, has been harnessed in the effort to reduce drug noncompliance.

However, all of the devices and methods presently in use suffer from a limitation which severely compromises their effectiveness in enhancing compliance; they lack an effective incentive for the user to maintain the device in his presence and as fail to ensure that the patient receives and acts upon the reminders provided thereby.

There is thus a widely recognized need for, and it would be highly advantageous to have, a medication reminder device devoid of the above limitation.

### SUMMARY OF INVENTION

An object of the present invention is to provide a medical reminder device with which a user will interact and from which the user receives medical regimen reminders.

According to a broad aspect of the present invention, there is provided a portable medication reminder device comprising a processing unit for generating a medication regimen and an interactive game and an output device for conveying the medication regimen and the interactive game to a user. The interactive game is specifically designed and configured for the purpose of motivating the user to interact therewith and thus to develop an avidity for the portable medication reminder device. The medication regimen forms a part of the interactive game and is conveyed to the user via the interactive game, thereby ensuring that it is communicated to the user.

According to features of the described preferred embodiment of the invention, the processing unit of the device includes a memory for storing user personal data, user medical data, and data pertinent to the interactive game.

According to further features of the described preferred embodiment of the invention, the output device is a display, a speaker, a vibratory apparatus or a combination of any of the three. The medication regimen is communicated to the user in a textual format, a graphical format, an audio format or a combination of any of the three.

According to further features of the described preferred embodiment of the invention, the device includes a data communication port which may be a hardwire port or a wireless port.

According to further features of the described preferred embodiment of the invention, the device includes a user interface for interacting with the interactive game and for inputting user data.

According to a further aspect of the present invention, there is provided a medication compliance system comprising the device described herein and at least one user client being in communication therewith. The user client may be a computer, a cellular telephone or a personal digital assistant. The user client is capable of receiving drug compliance information from the device and also capable of providing the device with data pertinent to the interactive game or the medication regimen.

According to further features of the medication compliance system described, communication between the device and the at least one user client is hardwire or wireless communication and is effected either directly or via a communication network such as the Internet.

According to a yet further aspect of the present invention, there is provided a method of communicating a medical regimen to a user comprising the step of providing a portable medication reminder device to the user, the portable medication reminder device being capable of generating a user specific medication regimen and an interactive game. The interactive game is designed and configured for the purpose of motivating the user to interact therewith and thus to develop an avidity for the portable medication reminder device thereby ensuring that the medication regimen is communicated to the user.

The present invention successfully addresses the shortcomings of the presently known configurations by providing a medication regimen reminder device which motivates a user to interact therewith and as such ensures a medication regimen reminder is communicated thereto.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a portable medication reminder device according to the present invention; and

FIG. 2 is a black box diagram of a medication compliance system according to the present invention.

### DESCRIPTION OF THE PREFERRED EMBODIMENTS

The present invention is of a medication reminder device and of systems and methods utilizing same which can be used to enhance and/or monitor the drug compliance of a user.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

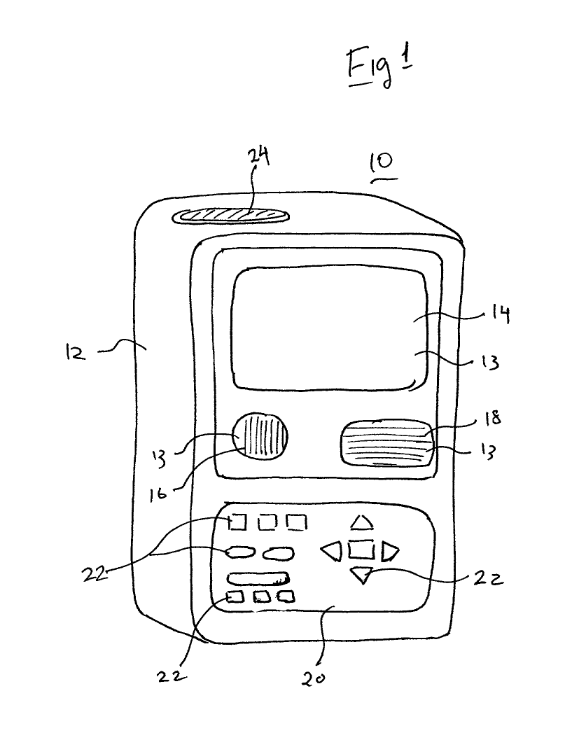

Referring now to the drawings, FIG. 1 illustrates a portable medication reminder device, which is referred to hereinafter as device 10.

Device 10 includes a body 12 which is sufficiently small in size and light in weight to be easily held in one hand, hung as a pendant or carried in the pocket or purse of a person.

Body 12 houses a processing unit which serves for generating a medication regimen and an interactive game from software applications stored in a memory device housed in body 12. The Memory device can be ram chip communicating with or forming a part of the processing unit or it can be any form of storage media either removable from, or permanently fixed within, body 12.

Device 10 further includes at least one output device 13 provided in or upon body 12. Output device 13 can be, but is not limited to, a display 14, which can be an LCD monochrome or color display, a speaker 16 or a vibratory apparatus 18 which is capable of conveying tactile sensations of varying frequencies. In addition, output device 13 can also be a scent producing apparatus, versions of which are known in the art.

Output device 13 serves for conveying the medication reminder and the interactive game to a user via visual, audible, tactile and/or olfactory information.

The interactive game can be any game which motivates the user to interact with device 10. For example, the interactive game can be a role playing game, an arcade game, a simulation game, a strategy game and the like. As is further described hereinbelow, device 10 is configured such that the type of interactive game provided thereby can be configured according to user preferences or needs.

To enable interaction with the interactive game, device 10 further includes a user interface 20 which includes a plurality of input buttons 22 which serve as game controls as well as input keys.

The medication reminder serves for reminding a user of device 10 to comply with a medication regimen. A reminder can be effected via textual, graphical tactile, auditory and/or olfactory messages which are provided to the user at predetermined time points, or at every predetermined time period. In addition, the medication reminder can also provide the user with additional information relevant to a drug taking regimen thereof. For example, the user can be reminded to eat before ingesting medication which is to be taken after a meal. In cases where a user's drug regimen includes more than one type of medication, the medication reminder can provide information relevant to the type of medication to be taken, the dosage and the like. In any case such information can be provided in any of the formats mentioned above.

Preferably, the reminder message is conveyed until the user acknowledges the receipt of the message by activating one or more buttons 22 of interface 20.

Thus, device 10 of the present invention provides the user with an interactive game which is designed and configured for motivating a user to interact with the device and thus develop an avidity thereto.

Such an avidity ensures that the user will keep device 10 close at hand at all times, ensuring that the medication regimen is communicated to the user, thus substantially enhancing drug compliance.

It will be appreciated that such an interactive game can generate an avidity for device 10 for a time period of weeks or months, which is sufficient to ensure drug compliance with transient medication regimens, and effective in educating a user to comply with a non-transient medication regimen.

It will be appreciated that although the medication regimen and interactive game can each be conveyed separately by device 10, linking the medication regimen to the interactive game provides several advantages.

Thus, according to one preferred embodiment of the present invention, the medication regimen is linked to the interactive game.

For example, the interactive game can be automatically paused to direct the users attention to a medication reminder message conveyed thereto. This further insures that a medication reminder is conveyed to a user.

The reminder and interactive game can be linked such that if a user does not acknowledge receipt of a reminder message within a predetermined time period, the reminder application pauses a game in progress or disables game launching or playing until the user acknowledges receipt of the message. The reminder application can also penalize a user for failing to acknowledge message receipt. Such penalizing can be effected by barring access to the interactive game and the like.

According to another preferred embodiment of the present invention, the medication regimen forms a part of the interactive game.

For example, a character of a role playing game can convey, preferably during the course of the interactive game, a medication reminder message via, for example, a voice message.

In this case, if the user does not acknowledge receipt, the content and delivery mode of the message can change and be more insistent or even authoritative.

One type of interactive game which would be suitable for this embodiment of the present invention is a virtual pet or a virtual patient game.

Virtual pet game devices such as the Tamaguchi game device (see http://www jitterbug.com/gvt/index.shtmi for further description) have generated a loyal following throughout the world. Users of Tamaguchi devices have been known to play and keep their devices for years and to care for the virtual pets generated thereby with passion and attention rivaling that given to real pets.

Therefore, the use of a virtual pet or patient interactive game for conveying medication reminders can be particularly effective.

Thus, a virtual patient which can be a reflection of the user can react to users input and provide medication reminders, which when not acknowledged can for example, cause a deterioration in the health state of the virtual patient.

Since device 10 motivates the user to interact therewith, it can be utilized to track the level of interaction and thereby provide information with respect to it's effectiveness in ensuring drug compliance of the user.

Accordingly, device 10 of the present invention can store information relating to the level of interaction between the user and device 10. Such information can include, for example, the number of times a user acknowledged receipt of the medication reminder messages, the time of day a user interacts with device 10 and the like.

Such information can be relayed from device 10 to a user client being in communication therewith either automatically or following a user provided command.

To enable such communication device 10 includes a communication port 24, which can be a hard wire communication port or a wireless communication port, such as an infrared port or a radio frequency (RF) port including an RF transceiver such as the BlueTooth chip (for further description of BlueTooth technology please see, for example, www.cellular.co.za/bluetooth.htm).

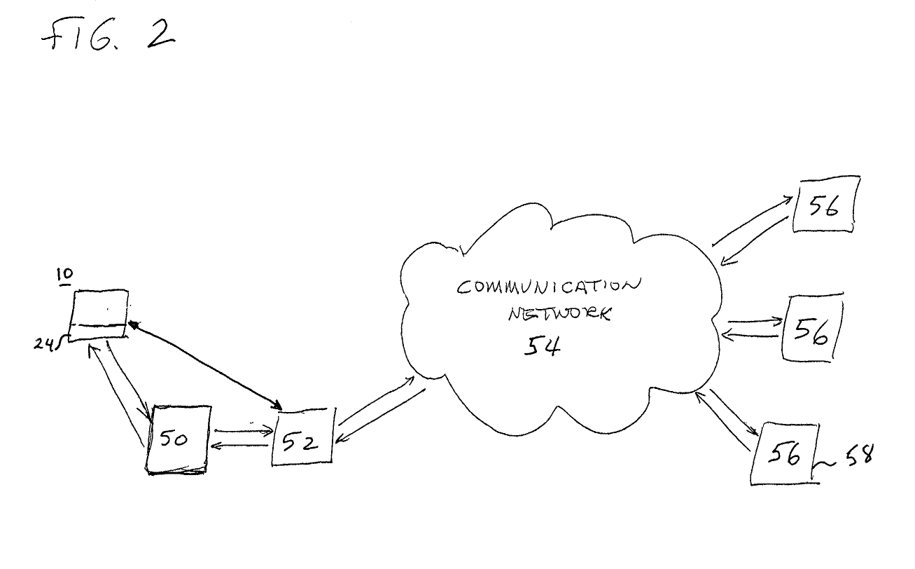

As specifically shown in FIG. 2, communication port 24 can enable on-site communication with a user client 50 or it can enable remote communication with a user client 56 enabled through user client 50 and/or server 52 which forms a part of a communication network 54.

As used herein, the phrase “user client” generally refers to a computer and includes, but is not limited to, personal computers (PC) having an operating system such as DOS, Windows, OS or Linux; Macintosh™ computers; computers having JAVA™-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones having Internet capabilities (e.g., wireless application protocol, WAP) and Web TVs.

The phrase “communication network” preferably refers to the Internet as manifested by the World Wide Web (WWW) of computers, although the medication compliance system of the present invention can also be implemented within Intranets or Extranets or any other open or closed communication network.

The information provided from device 10 can be useful to a treating physician or a caretaker (e.g. relative) of the user, or to a pharmacy from which the user acquires the medication prescribed.

The information can be provided as data which can be processed to enable analysis of user habits over a predetermined period of time, or alternatively, the information can be a simple warning message provided to, for example, a cell phone 58 of a relative.

It will be appreciated that since different medicaments require different regimen schedules and dosages, the medication regimen of device 10 of the present invention is programmable either by the user, using user interface 20, or by data inputted into device 10 via communication port 24. Such input can be from an on-site or a remotely located user client communicating with device 10 as described above.

It will be appreciated that the interactive game provided by device 10 can also be selected by the user and communicated to device 10 via communication port 24. The interactive game data can be provided from a pharmacy computer as described above or as a software download from a dedicated Internet Web site.

Preferably, the medication regimen is communicated to device 10 from an on-site pharmacy computer which provides the user with the prescribed medicament, thus ensuring proper medication regimen.

Device 10 of the present invention further stores medical information of the user, such as drug allergies and the like, as well as past and present medicaments taken thereby.

Communication of such information to, for example, a pharmacy computer prior to drug dispensing ensures that medicaments provided to the user will not trigger adverse drug reactions.

Thus, the present invention provides a medication reminder device which generates medication reminder messages and an interactive game, which motivates a user to interact with the device and as such, to be effectively provided with medication reminders therefrom.

In addition the medication reminder device of the present invention enables communication of device specific data to an on-site or remote computer, such as a computer of a treating physician or a pharmacy thus enabling a physician to track the users interaction with the device and to be provided with an indication of the user's drug compliance. Furthermore, such communication also enables the device of the present invention to receive information relevant to the drug regimen or interactive game stored in the device thus enabling the medication regimen and interactive game to be configured according to user preferences or needs.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A portable medication reminder device comprising
(a) processing unit being for generating a medication regimen and an interactive game; and
(b) at least one output device for conveying said medication regimen and interactive game to a user;
said interactive game being designed and configured for motivating a user to interact therewith and thus to develop an avidity for said portable medication reminder device, thereby ensuring that said medication regimen is communicated to said user.

2. The portable medication reminder device of claim 1, wherein said medication regimen is communicated to said user via said interactive game.

3. The portable medication reminder device of claim 1, wherein said medication regimen forms a part of said interactive game.

4. The portable medication reminder device of claim 1, wherein said medication regimen is communicated to said user in at least one format selected from the group consisting of a textual format, a graphical format and an audio format.

5. The portable medication reminder device of claim 1, further comprising a memory device storing user data and data pertinent to said interactive game.

6. The portable medication reminder device of claim 5, wherein said user data includes medical data.

7. The portable medication reminder device of claim 1, wherein said at least one output device is selected from the group consisting of a display, a speaker, and a vibratory apparatus.

8. The portable medication reminder device of claim 1, further comprising a data communication port.

9. The portable medication reminder device of claim 8, wherein said data communication port is a hard wire port or a wireless port.

10. The portable medication reminder device of claim 1, further comprising a user interface being for interacting with said interactive game.

11. The portable medication reminder device of claim 10, wherein said user interface further serves for inputting user data.

12. The portable medication reminder device of claim 1, further comprising a power source being for powering said processing unit and said at least one output device.

13. A medication compliance system comprising the device of claim 4 and at least one user client being in communication therewith, said at least one user client being capable of retrieving information from the device, said information being indicative of a medication compliance of a user of the device.

14. The medication compliance system of claim 13, wherein said at least one user client is also capable of providing the device with data pertinent to said interactive game or said medication regimen.

15. The medication compliance system of claim 13, wherein said at least one user client is selected from the group consisting of a computer, a cellular telephone and a personal digital assistant.

16. The medication compliance system of claim 13, wherein said communication between the device and said at least one user client is a hardwire or a wireless communication.

17. The medication compliance system of claim 13, wherein said communication between the device and said at least one user client is effected via a communication network.

18. The medication compliance system of claim 17, wherein said communication network is the Internet.

19. A method of communicating a medical regimen to a user comprising the step of providing a portable medication reminder device to said user, said portable medication reminder device being capable of generating a user specific medication regimen and an interactive game, said interactive game being designed and configured for the purpose of motivating a user to interact therewith and thus to develop an avidity for said portable medication reminder device thereby ensuring that said medication regimen is communicated to said user.

20. The method of claim 19, wherein said user specific medication regimen is communicated to said user via said interactive game

21. The method of claim 19, wherein said user specific medication regimen forms a part of said interactive game.
